(19) United States
(12) Patent Application Publication
(10) Pub. No.: US 2004/0165808 A1
(43) Pub. Date: Aug. 26, 2004

(54) Optical repolarizing devices

(75) Inventor: Jocelyn Lauzon, Saint-Augustin-de-Desmaures (CA)

Correspondence Address: MERCHANT & GOULD PC, P.O. BOX 2903, MINNEAPOLIS, MN, 55402-0903, US

(73) Assignee: INSTITUT NATIONAL D'OPTIQUE, Sainte-Foy (CA)

(21) Appl. No.: 10/370,665

(22) Filed: Feb. 20, 2003

(51) Int. Cl. G02B 6/00

(52) U.S. Cl. 385/11; 385/3; 385/8; 385/12; 359/483

(57) ABSTRACT

An optical repolarizing device for transforming either a randomly polarized or unpolarized input beam into a polarized output beam. A polarization dependent beam splitter splits both polarization components of the incident signal and inserts them into an interferometer. In one arm of the interferometer, a polarization rotator, equivalent to a half waveplate, is inserted. In the other arm of the interferometer, a phase shifter is inserted. The phase shifter ensures that there are no delays between the signals in the two interferometer arms, and thus there is constructive interference when the two beams, now having the same polarization, recombine at the output of the interferometer, where a beam combiner is provided for this purpose. For unpolarized input light, the phase shifter is unnecessary.

### FIELD OF THE INVENTION

The present invention relates to birefringent optical waveguides and more particularly concerns an optical device for reducing the polarization dependency of such waveguides.

### BACKGROUND OF THE INVENTION

Planar and integrated optics channel waveguides usually suffer from birefringence due to their associated fabrication methods and geometry. This means that the two orthogonal polarization components of a light beam transmitted through such a device would not be influenced by this device in the exact same way. Since randomly polarized light signals are used in general for applications such as optical communications and signal processing, this situation has to be dealt with in order to eliminate contamination of the signal due to the polarization-dependence of the optical waveguide. Moreover, the implementation of polarization-dependant waveguide devices should continue to increase in the future since they can offer photonic functions that cannot be obtained from symmetrically circular waveguide devices such as optical-fiber devices. These functions include large port count WDM channels MUX/DEMUX, optical switching, optical routing, wavelength conversion, active wavelength tunable filtering, and many others.

More and more, integrated optics channel waveguide devices are used within optical transmission links to offer some form of conditioning on the transmitted signal. Most of these channel waveguides are associated to a certain birefringence (effective refractive index difference between the two orthogonal axis of a waveguide) inducing some deterioration on the transmitted randomly polarized signal due to polarization effects. If the birefringence of the waveguide is small enough, the resulting polarization-dependent deterioration can be considered negligible. However, for some of these waveguides, the birefringence is strong and sometimes cannot be avoided if the function that is to be implemented on the signal by the waveguide is intrinsically polarization-dependent. Moreover, with the advent of optical transmission systems of increasing performance, with bit rates as high, or higher than 40 Gbps for some optical communication channels, polarization-dependent signal deterioration is harder and harder to cope with and to be neglected, and the tolerances on the birefringence parameters are becoming more and more difficult to be met. Thus, solutions that could help cope with the waveguide birefringence have to be considered.

Such solutions already exist, the simplest one being to split the incident, randomly polarized signal, into its two orthogonally polarized components that can then be used as independent light beams, treated independently, in parallel, into two equivalent integrated optics channel waveguide devices before being recombined into one at the output of the device. It is a proven functional approach. However, it is a costly approach, one that requires to double the number of components of a device and to add splitters and combiners. It is also an approach that needs to be implemented with a lot of care in order to ensure that both parallel devices create the same delay on the separate polarization components in order to minimize PMD (Polarization Mode Dispersion) at the output of the device.

Another approach is to insert a polarizer in front of the device to make sure only the correct polarization is inserted into the birefringent device. This approach has the advantage of being simple and low-cost, however it is associated with large power losses (3 dB in the case of a circularly polarized input beam) that can substantially vary if there is polarization coupling or rotation of the incident signal light beam.

Also known in the art are specific devices configured so as to be polarization independent. Such a device is for example disclosed in U.S. Pat. No. 6,304,380 (DOERR) for the case of equalizers having a chromatically variable transmissivity. DOERR teaches the separation of the two orthogonal polarization components of an input light beam and propagating them through the apparatus in opposite directions. They are then recombined to form the final output beam. This apparatus is therefore a double-pass device made to ensure polarization independence, and DOERR does not address the combination of the signals from both paths into one having a single polarization, after having been subjected to constructive interference.

There is therefore a need for a simple low-cost solution to cope with the polarization dependence of waveguides that alleviates the drawbacks of the prior art.

### SUMMARY OF THE INVENTION

An object of the present invention is to provide an optical repolarizing device for transforming an input light beam into a polarized output light beam.

A preferential object of the present invention is to provide such a light polarizing device adapted for randomly polarized input light.

Another preferential object of the present invention is to provide such a light polarizing device adapted for unpolarized input light.

According to a first aspect of the present invention, there is therefore provided an optical repolarizing device for transforming a randomly polarized input light beam into a polarized output light beam. The input light beam has first and second signal components having polarizations orthogonal to each other.

The device includes a polarization-dependent beam splitter for splitting the input light beam into the first and second signal components. First and second polarization maintaining light paths are provided, both having opposite input and output ends. The input ends of the first and second light paths are optically coupled to the polarization-dependent beam splitter for respectively receiving therefrom the first and second signal components.

A polarization rotator is disposed in the first light path for orthogonally rotating the polarization of the first signal component propagating therethrough. Phase adjusting means are also provided for adjusting a phase difference between the first and second signal components in order to provide a constructive interference of the first and second signal components at the output ends of the first and second light paths.

Finally, a beam combiner is optically coupled to the output ends of the first and second light paths for receiving therefrom the first and second signal components, and combining them into the polarized output light beam.

According to a second aspect of the present invention, there is also provided an optical repolarizing device for transforming an unpolarized input light beam into a polarized output light beam, the input light beam having a first and a second signal component having polarizations orthogonal to each other. This light repolarizing device also includes a polarization-dependent beam splitter for splitting the input light beam into the first and second signal components, and a first and a second polarization maintaining light paths both having opposite input and output ends. The input ends of the first and second light paths are optically coupled to the polarization-dependent beam splitter for respectively receiving therefrom the first and second signal components. A polarization rotator is disposed in the first light path for orthogonally rotating the polarization of the first signal component propagating therethrough. A beam combiner is optically coupled to the output ends of the first and second light paths for receiving therefrom the first and second signal components, and combining them into the polarized output light beam.

Advantageously, the present invention enables the fabrication of adaptable, low-loss integrated optics channel waveguide polarizing devices compatible with other channel waveguide devices. The configuration is universal in that it can be implemented to be used with any polarization-dependent waveguide device. It can be used to make potentially low-cost, very robust and compact devices. The configuration is preferably implemented in a sufficiently optically transparent material being birefringent and favourably electro-optic.

Other features and advantages of the present invention will be better understood upon reading of preferred embodiments thereof with reference to the appended drawings.

### BRIEF DESCRIPTION OF THE DRAWINGS

FIG. 1 is a schematic representation of a light polarizing device according to one embodiment of the present invention.

FIG. 2 is a schematic representation of a light polarizing device according to another embodiment of the present invention.

### DESCRIPTION OF PREFERRED EMBODIMENTS OF THE INVENTION

The present invention generally addresses the question of the polarization-dependence of waveguides by taking a randomly polarized or an unpolarized input beam and making a polarized beam out of it, thus “repolarizing” the input beam light signal.

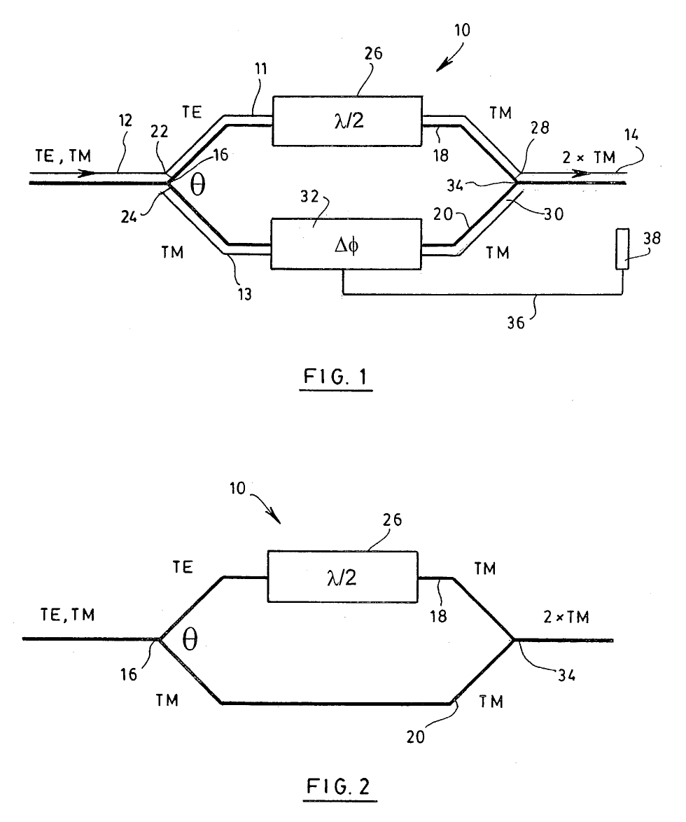

Referring to FIG. 1, there is shown a polarizing device 10 according to a first embodiment of the present invention, which transforms a randomly polarized input light beam 12 into a polarized output light beam 14. The input light beam 12 has first and second signal components 11 and 13 orthogonal to each other. These designations are preferably assigned relative to the geometry of the device and the manner in which the polarization of the input beam is affected thereby. In the illustrated embodiment, the first signal component 11 corresponds to the TE polarization mode whereas the second signal component 13 corresponds to the TM mode. By “randomly polarized” input light beam it is generally meant that the two signal components 11 and 13 of the input beam are coherent but randomly oriented with respect to the geometry of the device. Their intensities may be either variable or fixed with time.

The device 10 includes a polarization-dependent beam splitter 16 which receives the input light beam 12 and splits it into the first and second signal components 11 and 13. A polarization splitter Y coupler is preferably used for this purpose, such as for example disclosed in A. Neyer, “Low-crosstalk passive polarization splitters using Ti:LiNbO3 waveguide crossings”, Appl. Phys. Lett., vol 55, # 10, September 1989, pp. 927-929, which is incorporated herein by reference. The beam splitter 16 is optically coupled to the input ends 22 and 24 of first and a second polarization maintaining light paths 18 and 20, to respectively send therein the first and second signal components 11 and 13.

Preferably, the first and second light paths 18 and 20 define the two branches of a Mach-Zehnder interferometer; in the first light path 18 a polarization rotator 26 is provided for orthogonally rotating, that is, rotating by 90° the polarization of the first signal component 11 propagating therethrough. In the illustrated example, the TE polarization is rotated into TM polarization. The polarization rotator is preferably the integrated equivalent of a half waveplate, and is usually made to be fixed. It can however be made to be adjustable if, for example, one needs to implement a certain attenuation on the repolarized output signal. Techniques to manufacture an appropriate polarization rotator are known in the art, and reference may for example be made to the polarization converter disclosed in S. Thaniyavarn, “Wavelength independent, optical damage immune Z-propagation LiNbO3 waveguide polarization converter”, Appl. Phys. Lett., vol. 47, # 7, October 1985, pp. 674-677 (with particular reference to FIGS. 1 and 5) or to the polarization transformer disclosed in R. C. Alferness et al., <<Waveguide electro-optic polarization transformer >>, Appl. Phys. Left., vol. 38, # 9, May 1981, pp. 655-657. Both of these documents are incorporated herein by reference.

Phase adjusting means for adjusting the phase difference between the first and second signal components are provided to ensure a constructive interference of the first and second signal components at the output ends 20 and 30 of the first and second light paths 10 and 20. Preferably, a phase shifter 32 is disposed in the second light path 20 for this purpose. The phase shifter may for example be made as disclosed in Ed L. Wooten et al., “A review of lithium niobate modulators for fiber-optic communications systems”, IEEE Journal of selected topics in quantum electronics, vol. 6, # 1, January/February 2000, pp. 69-81, or at pages 700-702 of Saleh and Teich, “Fundamentals of Photonics” John Wiley and Sons, both of which are incorporated herein by reference. Alternatively, if the relative phase between the two polarizations is well-known and is fixed, the adjustable phase shifter option is no longer mandatory as long as the two interferometer arms are designed to ensure constructive interference at the output.

Finally, a beam combiner 34, such as a recombination Y coupler is optically coupled to the output ends 28 and 30 of the first and second light paths 18 and 20 for receiving therefrom the first and second signal components 11 and 13, which are now both aligned with the TM mode, and combining them into the polarized output light beam 14. With properly selected parameters of the device, all of the input power will be transferred into the output beam 14 with negligible losses. In this embodiment, the output beam 14 is linearly polarized along the TM mode, but of course, TE polarization could easily be obtained by simply switching the first and second signal components 11 and 13 (that is, sending the TM component into the branch having the polarization rotator).

The repolarizing device as described above works for variable input polarization states with negligible variations of the PMD with time. If the PMD varies significantly with time, as is usually the case in long-haul optical fiber transmission links, a feedback loop 36 has to be implemented between the phase shifter 32 and a tapped signal monitor 38 at the output of the repolarizer; by optimizing the output power at the monitor level, through phase shifter adjustments, the PMD variations can be compensated for in order to obtain a power stable truly repolarized signal at the output of the device.

The present invention is particularly advantageous in the context of integrated waveguide devices. In such a case, the beam splitter, first and second light paths and beam combiner may all be integrated into a single substrate, preferably made of an electro-optic material such as lithium niobate. This configuration can thus be universally integrated to any other integrated optics polarization-dependent channel waveguide devices without having to care about PMD. Coupling between the repolarizer device and other integrated devices can be minimized by implementing the repolarizer geometry on the same substrate as this other integrated device; thus in fact reaching higher integration levels on the given substrate. It is a potentially low-cost solution, since it can be made by an automated fabrication process and it can become a commodity product used in large-scales on a large scale because it is adaptable to any polarization-dependent channel waveguide components, regardless of their applications. It is a very robust, solid-state solution based on proven technologies that should be Telcordia qualified without any modifications.

Referring to FIG. 2, there is illustrated a second preferred embodiment of the present invention. In this case, the repolarizer device 10 is used to get a polarized output out of a totally unpolarized input beam. By “unpolarized”, it is meant that there is total incoherence between the polarization of the signal components of the input beam. This is for example the case for the Amplified Spontaneous Emission (ASE) of a superfluorescent rare-earth doped fiber light source. In these conditions the power from both arms of the interferometer will simply add to each other at the output, without any considerations as to destructive and constructive interference. This thus means that the phase shifter in the second arm of the interferometer is not mandatory. The repolarizing device 10 therefore simply includes the polarization-dependent beam splitter 16, beam combiner 34 and the two light paths 18 and 20 in-between, a polarization rotator 26 being disposed in one of those light paths.

It will be noted that the repolarizer according to the preferred embodiment of the present invention can work over a certain wavelength bandwidth. This bandwidth can be quite large, allowing the simultaneous treatment of multiple WDM channels, however it is not infinite. The bandwidth is initially limited by the material used to make the repolarizer. It can also be limited by the channel waveguides characteristics. It is also limited by the polarization rotator and phase shifter bandwidth. All these limitations are not very restrictive, bandwidths of many tens of nanometers can be allowed if the repolarizer is designed properly. A last possible limitation is second order PMD, PMD that varies with wavelength. This parameter is usually quite negligible over bandwidths of a few tens of nanometers, but it should be considered. It should also be noted that if the WDM channels are randomly polarized from another (for optical communication systems that are not point-to-point for example), the repolarizer will only work for one wavelength channel at a time.

In summary, the present invention takes either a randomly polarized or unpolarized input beam and makes a polarized beam out of it; thus repolarize the input beam light signal. In order to avoid the disadvantages associated with the polarizer approach, the repolarizer should limit the transmission losses and should be insensitive to polarization coupling or rotation of the incident signal light beam. One way to implement a repolarizer having these qualities is to split both signal components of the incident signal and insert them into an interferometer. In one arm of the interferometer, a polarization rotator, equivalent to a half waveplate, is inserted. In the other arm of the interferometer, a phase shifter is inserted. The phase shifter ensures that there are no delays between the signals in the two interferometer arms, and thus there is constructive interference when the two beams, now having the same polarization, recombine at the output of the repolarizer. For unpolarized light, the phase shifter is unnecessary. In this approach, there are no polarization-dependent losses. If the device is designed correctly, the coupling losses to the device and the transmission losses within the device should be minimal. The device is insensitive to the incident polarization state of the input light beam since it recombines into one whatever optical power it has in both of the interferometer arms, without any discrimination. The device also has the advantage of ensuring minimal PMD on the output repolarized beam since the constructive interference only occurs when there is no delay between the two arms of the interferometer. Thus, an indirect application of the repolarizer could be to act as a PMD compensator.

Of course, numerous modifications could be made to the embodiments described above without departing from the scope of the invention as defined in the appended claims.

1. An optical repolarizing device for transforming a randomly polarized input light beam into a polarized output light beam, said input light beam having a first and a second signal component having polarizations orthogonal to each other, the light polarizing device comprising:
a polarization-dependent beam splitter for splitting the input light beam into said first and second signal components;
first and second polarization maintaining light paths both having opposite input and output ends, said input ends of the first and second light paths being optically coupled to the polarization-dependent beam splitter for respectively receiving therefrom the first and second signal components;
a polarization rotator disposed in the first light path for orthogonally rotating the polarization of the first signal component propagating therethrough;
phase adjusting means for adjusting a phase difference between the first and second signal components to provide a constructive interference of said first and second signal components at the output ends of the first and second light paths; and
a beam combiner optically coupled to the output ends of the first and second light paths for receiving therefrom the first and second signal components and combining the same into said polarized output light beam.

2. An optical repolarizing device according to claim 1, where the phase adjusting means comprise a phase shifter disposed in the second light path for inducing a phase shift of the second signal component propagating therethrough.

3. An optical repolarizing device according to claim 1, wherein the phase adjusting means comprise a design of the first and second light paths between the first and second ends thereof selected to provide said constructive interference.

4. An optical repolarizing device according to claim 1, further comprising:
monitoring means for monitoring an intensity of the output light beam; and
a feedback loop for controlling the phase shifter with respect to said monitoring.

5. An optical repolarizing device according to claim 1, wherein the polarization-dependent beam splitter is a Y-coupler defined by an intersection of an input waveguide and the first and second light paths, said first and second light paths making an angle θ selected to split the input light beam into said first and second signal components.

6. An optical repolarizing device according to claim 1, wherein the beam combiner is a Y-coupler defined by an intersection of the first and second light paths and an output waveguide.

7. An optical repolarizing device according to claim 1, wherein said beam splitter, first and second polarization maintaining light paths and beam combiner are integrated into a single substrate.

8. An optical repolarizing device according to claim 7, wherein said beam splitter, first and second polarization maintaining light paths and beam combiner are defined by channel waveguides.

9. An optical repolarizing device according to claim 8, wherein said substrate is made of an electro-optic material.

10. An optical repolarizing device according to claim 9, wherein said electro-optic material is lithium niobate.

11. An optical repolarizing device for transforming an unpolarized input light beam into a polarized output light beam, said input light beam having incoherent first and second signal components having polarizations orthogonal to each other, the light polarizing device comprising:
a polarization-dependent beam splitter for splitting the input light beam into said first and second signal components;
first and second polarization maintaining light paths both having opposite input and output ends, said input ends of the first and second light paths being optically coupled to the polarization-dependent beam splitter for respectively receiving therefrom the first and second signal components;
a polarization rotator disposed in the first light path for orthogonally rotating the polarization of the first signal component propagating therethrough; and
a beam combiner optically coupled to the output ends of the first and second light paths for receiving therefrom the first and second signal components and combining the same into said polarized output light beam.

12. An optical repolarizing device according to claim 1, wherein the polarization-dependent beam splitter is a Y-coupler defined by an intersection of an input waveguide and the first and second light paths, said first and second light paths making an angle θ selected to split the input light beam into said first and second signal components.

13. An optical repolarizing device according to claim 1, wherein the beam combiner is a Y-coupler defined by an intersection of the first and second light paths and an output waveguide.

14. An optical repolarizing device according to claim 11, wherein said beam splitter, first and second polarization maintaining light paths and beam combiner are integrated into a single substrate.

15. An optical repolarizing device according to claim 13, wherein said beam splitter, first and second polarization maintaining light paths and beam combiner are defined by channel waveguides.

16. An optical repolarizing device according to claim 15, wherein said substrate is made of an electro-optic material.

17. An optical repolarizing device according to claim 16, wherein said electro-optic material is lithium niobate.
